(19) United States
(12) Patent Application Publication
(10) Pub. No.: US 2017/0329409 A9
(43) Pub. Date: Nov. 16, 2017

(54) SMART GLASSES, AND SYSTEM AND METHOD FOR PROCESSING HAND GESTURE COMMAND THEREFOR

(71) Applicants: INSIGNAL Co., Ltd., Seoul (KR); Industry-University Cooperation Foundation of Korea Aerospace University, Goyang-si (KR)

(72) Inventors: Sung Moon CHUN, Suwon-si (KR); Hyun Chul KO, Jeju-si (KR); Jae Gon KIM, Goyang-si (KR)

(73) Assignees: INSIGNAL Co., Ltd., Seoul (KR); Industry-University Cooperation Foundation of Korea Aerospace University, Goyang-si (KR)

(21) Appl. No.: 15/179,028

(22) Filed: Jun. 10, 2016

(30) Foreign Application Priority Data
Jun. 12, 2015 (KR) 10-2015-0083621
Oct. 12, 2015 (KR) 10-2015-0142432
Dec. 11, 2015 (KR) 10-2015-0177012
Dec. 11, 2015 (KR) 10-2015-0177017

(51) Int. Cl. G06F 3/01; G06F 1/16; G02B 27/01; G06T 7/194; G06K 9/00; G06T 7/12; H04N 13/02; G06F 3/03; G06T 7/174

(52) U.S. Cl. CPC G06F 3/017; G06F 3/0304; G06F 3/011; G06F 1/163; G02B 27/01; G06T 7/174; G06K 9/00389; G06T 7/12; H04N 13/0271; H04N 13/0203; G06T 7/194; G06T 2207/10028; G06T 2207/30196

(57) ABSTRACT

Smart glasses, and a system and method for processing a hand gesture command using the smart glasses. According to an exemplary embodiment, the system includes smart glasses to capture a series of images including a hand gesture of a user and represent and transmit a hand image, included in each of the series of images, as hand representation data that is represented in a predetermined format of metadata; and a gesture recognition apparatus to recognize the hand gesture of a user by using the hand representation data of the series of images received from the smart glasses, and generate and transmit a gesture command corresponding to the recognized hand gesture.

### CROSS-REFERENCE TO RELATED APPLICATION(S)

This application claims priority from Korean Patent Application Nos. 10-2015-0083621, filed on Jun. 12, 2015, 10-2015-0142432, filed on Oct. 12, 2015, 10-2015-0177012, filed on Dec. 11, 2015, and 10-2015-0177017, filed on Dec. 11, 2015, in the Korean Intellectual Property Office, the entire disclosures of which are incorporated herein by references for all purposes.

### BACKGROUND

### 1. Field

The following description relates to a technology using wearable electronic devices, and more specifically, to a technology for recognizing and processing hand gesture commands by using smart glasses.

### 2. Description of the Related Art

The wide dissemination of portable smart electronic devices, e.g., smartphones and tablet computers, etc., has gradually brought about the dissemination of wearable electronic devices, e.g., smart bands, smart watches, smart glasses, etc. A wearable electronic device refers to a piece of equipment that can be worn on or embedded into a human body, and more specifically, to a communicable device connected directly to networks or through other electronic devices, e.g., smartphones.

Wearable electronic devices have unique characteristics depending on their purpose, uses, etc., and there may be certain limitations due to the product's shape, size, material, etc. For example, among other wearable electronic devices, smart glasses can be used as a private display for a wearer. In addition, smart glasses that are equipped with a camera allow the user to easily take photos or film videos of what is in his or her field of view. Furthermore, due to its structure, equipping the smart glasses with a binocular stereo camera is also easy. In this case, it is also possible to acquire stereo videos having the same view with a person's, whereby said stereo camera allows the user to capture 3D videos of what is in his or her field of view. Due to these characteristics, a method of user gesture recognition is an area that is actively being researched, so that smart glasses may recognize said user's facial expressions and hand gestures, and then recognize and process them as user commands

However, the smart glasses have limitations due to the anatomical location where it is worn and their shape, thus making it difficult for widely used input devices, e.g., keypads or touchscreen, to be installed therein. Also, there is a weight limitation, as well as a need for minimizing the amount of heat generated and electromagnetic waves, as well as its weight. An operation of processing hand gesture commands, which includes an operation of processing images and recognizing gestures, requires a high-performance processor, and to that end, also requires a battery that has significantly large capacity. But because of design restrictions, as well as limitations due to the fact that they are worn on a user's face, it is hard to mount a high-performance processor that consumes a lot of power and/or generates much heat, as well as performs numerous calculations.

Accordingly, what is needed is a new technology that makes full use of the above-mentioned features of smart glasses in order to process hand gesture commands, and yet is able to overcome the restrictions and limitations caused in relation to product design or the anatomical location upon which said glasses are worn.

### SUMMARY

One purpose of the following description is to provide smart glasses that overcome characteristics related to smart glasses, such as the fact that they are small, have a lot of limitations in product design, and are worn on the face; and to provide a system and method for processing hand gesture commands

Another purpose of the following description is to provide smart glasses that are usable in various fields of application; and to provide a system and method for processing hand gesture commands

Another purpose of the following description is to provide smart glasses that use relatively low power, and even with a low-performance processor installed therein, can efficiently recognize and process a hand gesture command; and to provide a system and method for processing hand gesture commands

In one general aspect, smart glasses for a gesture recognition apparatus that recognizes a hand gesture of a user and generates a gesture command corresponding to the recognized hand gesture, the smart glasses includes: a camera unit to capture a series of images including the hand gesture of a user; a detection and representation unit to represent a hand image, included in each of the series of images, as hand representation data that is represented in a predetermined format of metadata; and a communication unit to transmit the hand representation data, generated by the detection and representation unit, to the gesture recognition apparatus.

The camera unit may include a stereoscopic camera, and the series of images may be a series of left and right images that are captured by using the stereoscopic camera.

The camera unit may include a depth camera, and the series of images may be a series of depth-map images that are captured by using the depth camera.

The detection and representation unit may distinguish between a hand area and a background area by using a depth map of each of the series of images, and represent the hand area as hand representation data. The hand representation data may represent a boundary line of the hand area with a Bézier curve. The detection and representation unit may determine pixels, located within a predetermined distance, as the hand area by using the depth map. The detection and representation unit may convert the depth map of each of the series of images into a depth-map image that is represented in a predetermined bit gray level, distinguish between the hand area and the background area from the depth-map image, represent the background area all in a gray level of ‘0’, perform filtering on the hand area, and represent the hand area as the hand representation data. The detection and representation unit may generate a histogram of a pixel frequency, and distinguish between the hand area and the background area by defining, as a boundary value, a gray level of which a pixel frequency is relatively small, but the pixel frequencies before and after the gray level are bigger.

In another general aspect, a system for processing a hand gesture command includes: smart glasses to capture a series of images including a hand gesture of a user, and represent and transmit a hand image, included in each of the series of images, as hand representation data that is represented in a predetermined format of metadata; and a gesture recognition apparatus to recognize the hand gesture of a user by using the hand representation data of the series of images received from the smart glasses, and generate and transmit a gesture command corresponding to the recognized hand gesture.

The smart glasses may distinguish between a hand area and a background area by using a depth map of each of the series of images, and represent the hand area as hand representation data. The hand representation data may represent a boundary line of the hand area with a Bézier curve. The smart glasses may determine pixels, located within a predetermined distance, as the hand area by using the depth map. The smart glasses may convert the depth map of each of the series of images into a depth-map image that is represented in a predetermined bit gray level, distinguish between the hand area and the background area from the depth-map image, represent the background area all in a gray level of ‘0’, perform filtering on the hand area, and represent the hand area as the hand representation data. The smart glasses may generate a histogram of a pixel frequency, and distinguish between the hand area and the background area by defining, as a boundary value, a gray level of which a pixel frequency is relatively small, but the pixel frequencies before and after the gray level are bigger.

The gesture recognition apparatus may store a gesture and command comparison table, which represents a correspondence relation between a plurality of hand gestures and gesture commands that correspond to each of the plurality of hand gestures, and based on the gesture and command comparison table, determine a gesture command corresponding to the recognized hand gesture. The gesture and command comparison table may be set by the user.

The gesture recognition apparatus may transmit the generated gesture command to the smart glasses or another electronic device to be controlled by the user.

In another general aspect, a method of processing a hand gesture includes: capturing a series of images including a hand gesture of a user; representing a hand image, included in each of the series of images, as hand representation data that is represented in a predetermined format of metadata; transmitting the hand representation data to a gesture recognition apparatus; recognizing, by the gesture recognition apparatus, the hand gesture of a user by using the hand representation data of the series of images received from the smart glasses, and generate and transmit a gesture command corresponding to the recognized hand gesture; and generating and transmitting a gesture command corresponding to the recognized hand gesture.

The representing of the hand image as the hand representation data may include distinguishing between the hand area and the background area by using a depth map of each of the series of images, and then representing the hand area as the hand representation data.

Other features and aspects may be apparent from the following detailed description, the drawings, and the claims.

### BRIEF DESCRIPTION OF THE DRAWINGS

FIG. 1 is a flowchart illustrating a method of processing hand gesture commands according to an exemplary embodiment.

FIG. 2 is a schematic diagram illustrating a system for processing hand gesture commands, which can perform the method of processing hand gesture commands as illustrated in FIG. 1.

FIG. 3 is a perspective view illustrating a shape of the smart glasses of FIG. 2.

FIG. 4 is a diagram illustrating an example of representing, in an image, a depth map that is generated by the smart glasses of FIG. 2.

FIG. 5 is a graph illustrating a histogram of entire pixels forming the image of the depth map of FIG. 4.

FIG. 6 is a diagram illustrating a gray-level image that was rendered by allocating an image level value of ‘0’ to a background area of the depth-map image of FIG. 4.

FIG. 7 is a diagram illustrating an example of an image that may be acquired after a filtering technique has been applied to the gray-level image of FIG. 6.

FIG. 8A is a diagram, taken from the image of FIG. 7, illustrating a part of the step in the process of showing boundary lines or contours of the hand image using a Bézier curve.

FIG. 8B is a diagram illustrating a part of Bézier curve data that shows boundary lines of the hand image of FIG. 7. according to the process of FIG. 8A.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Also, the terms and words used herein are defined in consideration of the functions of elements in the present invention. The terms can be changed according to the intentions or the customs of a user and an operator. Accordingly, the terms that will be described in the flowing exemplary embodiments may be used on the basis of the following definition if they are specifically defined in the following description, whereas if there are no detailed definitions thereof, the terms may be construed as having the general definitions.

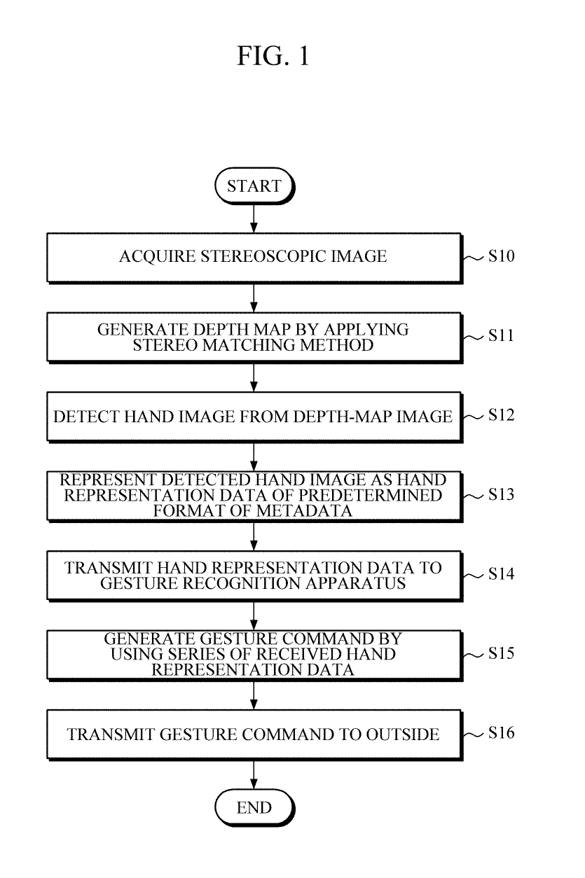

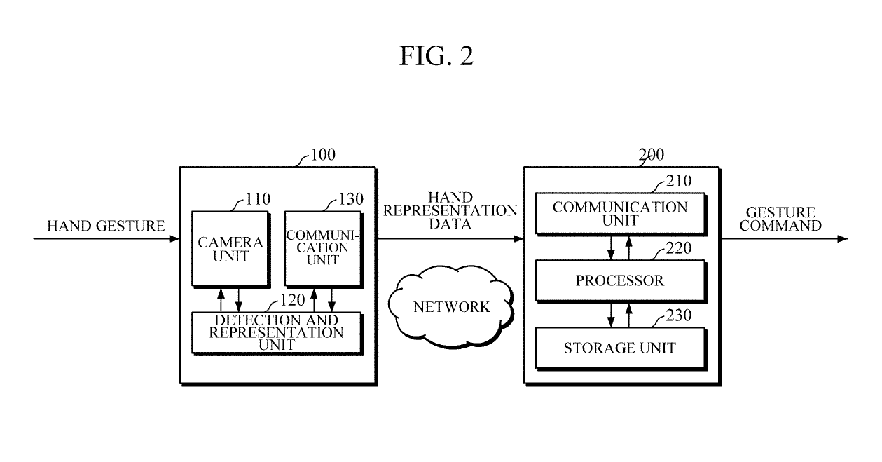

FIG. 1 is a flowchart illustrating a method of processing hand gesture commands according to an exemplary embodiment. FIG. 2 is a schematic diagram illustrating a system for processing hand gesture commands, which can perform the method of processing hand gesture commands as illustrated in FIG. 1. FIG. 2 includes smart glasses 100 and a gesture recognition apparatus 200.

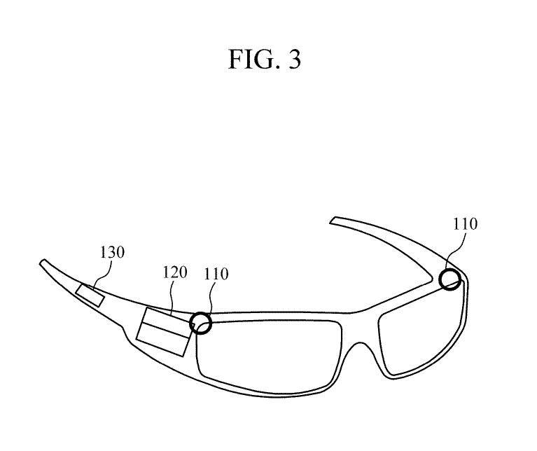

The smart glasses 100 are an apparatus that captures a user's hand gesture, generates hand representation data from each of the frame images that compose this captured video, and transmits the generated data to the gesture recognition apparatus 200. FIG. 3 is a perspective view illustrating the shape of the smart glasses. Referring to FIGS. 2 and 3, the smart glasses 100 may include a camera unit 110, a detection and representation unit 120, and a communication unit 130.

The gesture recognition apparatus 200 recognizes hand gestures by using a series of hand representation data which has been received from the smart glasses 100, and outputs a gesture command corresponding to the recognized hand gestures. To this end, the gesture recognition apparatus 200 includes a communication unit 210, a processor 220, and storage unit 230. The gesture recognition apparatus 200 is a device that processes the recognition of hand gestures instead of the smart glasses 100, so that the gesture recognition apparatus 200 may be a server or host to the smart glasses 100. Thus, the gesture recognition apparatus 200 may be implemented as one part of or one function of a device that acts as a server or host for a user's smart glasses 100.

Alternatively, according to an exemplary embodiment, the gesture recognition apparatus 200 may be implemented as a function or application of a device that can communicate with the smart glasses 100, e.g., smart phones or tablet computer, and that may exhibit greater level of processing than the smart glasses 100.

Hereinafter, a method for processing hand gesture commands according to an exemplary embodiment is specifically described with reference to FIGS. 1 through 3.

Referring to FIGS. 1 through 3, a camera unit 110 of smart glasses 100 acquires a series of stereoscopic images, e.g., a sequence of left and right images in 10. The camera unit 110 is a device that continuously captures images for a predetermined period of time, i.e., a device for acquiring an image sequence, and more specifically, a device that captures the sequence of the user's hand gestures. To this end, the camera unit 110 may be attached to or embedded in the frame of the smart glasses 100 in order to film an area that is in front of said glasses 100, or in other words, in the user's field of view. However, the exemplary embodiment is not only limited thereto, and the camera unit 110 may be physically implemented in the smart glasses 100 in a different way.

The camera unit 110 captures and transmits the image sequence so that the detection and representation unit 120 may detect a user's hand from within the captured images. Thus, the image sequence, which the camera unit 110 captures and transmits to the detection and representation unit 120, may be changed according to an algorithm that is used for the detection of the user's hand by the detection and representation unit 120. As described later, there is no specific restrictions with regards to the algorithm used for the detection of the hand by the detection and representation unit 120, which in turn means that there is also no specific restriction in the type of a camera installed in the camera unit 110.

In one exemplary embodiment, the camera unit 110 may include a stereoscopic camera. The stereoscopic camera is, in a sense, a pair of cameras, whereby the stereoscopic camera houses a left camera and a right camera which are spaced apart from each other in a predetermined distance. The stereoscopic camera is capable of filming a subject in a manner that simulates human vision, thus making it possible to capture a natural, stereoscopic image, or in other words, to jointly acquire a pair of left and right images.

In another exemplary embodiment, the camera unit 110 may include a depth camera. The depth camera refers to a camera that can irradiate light, e.g., infrared ray (IR), to a subject and subsequently acquire data regarding a distance to the subject. By using a depth camera, the user has the advantage of being able to immediately acquire depth information regarding the subject, i.e., a depth map. However, there are also disadvantages like the fact that a light source, e.g., a light emitting diode (LED) that can emit IR, is additionally required, as well as the fact that there is high power consumption at the light source, . Below, functions of a detection and representation unit 120, in a case where the camera unit 110 includes a stereoscopic camera, are specifically described, but said functions can be also applied in a case where the camera unit 110 includes a depth camera. For this case, the functions of the detection and representation unit 120 will be described later, among which certain operations leading up to the acquisition of a depth map may be omitted.

Referring once again to FIGS. 1 through 3, the detection and representation unit 120 in the smart glasses 100 generates a depth map by applying a stereo matching method to each stereoscopic image included in a series of the acquired stereoscopic images in 11. Then, the detection and representation unit 120 represents the depth map in a gray level to generate a depth-map image and detects a hand image by distinguishing between a hand area and a background area from the depth-map image in 12. Then, the detection and representation unit 120 represents the detected hand image as hand representation data of a predetermined format of metadata in 13, and transmits the hand representation data to a gesture recognition apparatus 200 in 14. These operations 11 through 14 may be performed at the detection and representation unit 120 of the smart glasses 100, which will be described in detail hereinafter.

The detection and representation unit 120 detects a user's hand by using the stereoscopic images acquired from the camera unit 110. Here, the ‘user's hand’ refers to a means for inputting a predetermined command that is represented with gestures in an electronic device that the user intends to control. As described later, the electronic device that the user intends to control is not limited to the smart glasses 100, so the gesture command output from the gesture recognition apparatus 200 may be performed not by the smart glasses 100, but other electronic devices, such as a multimedia device of a smartphone or a smart TV. Thus, in order to perform the aforementioned functions, other detections aside from a user's hand may be detected by the detection and representation unit 120, whereby the camera unit 110 will, of course, capture and acquire a sequence of images including the detection subject.

There is no specific limitation to the manner by which a detection and representation unit 120 may detect a user's hand. For example, the detection and representation unit 120 first receives data of each left and right image transmitted from the camera unit 110, i.e., data of a pair of image frames that were acquired at the same period of time. Both left and right images may be RGB images. Then, the detection and representation unit 120 generates a depth map by using both of the RGB images that have been transmitted from the camera unit 110. The detection and representation unit 120 may generate a depth map by applying a predetermined algorithm, e.g., a stereo matching method, both RGB images.

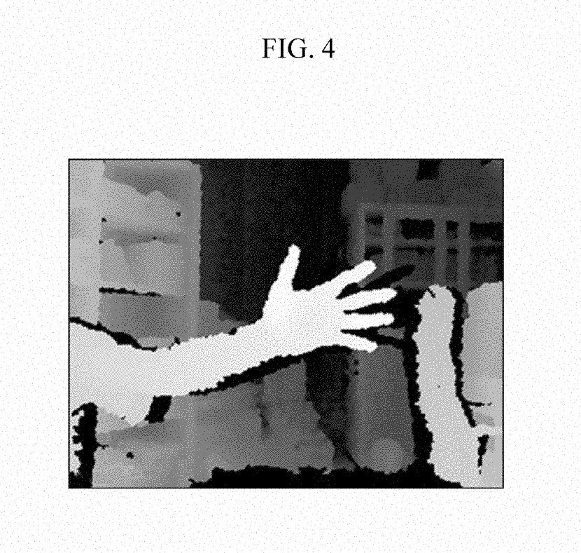

FIG. 4 is a diagram illustrating an example of representing, in an image, a depth map that is generated by the smart glasses of FIG. 2. The depth map refers to data representing a distance between a camera unit 110 and a subject in a predetermined value. For example, the depth map may refer to a set of data expressed in 8-bit units, whereby the farthest distance between the camera unit 110 to the subject has been divided into what is the equivalent of 2⁸, or 256, ‘ranges’, and so each of the ranges corresponds to a certain value of the pixel unit that is between 0 to 255. The depth-map image illustrated in FIG. 4 is a depth map in pixel units in a gray level. Generally, in a gray-level image, a pixel depicting an image that is close by is shown to be brighter, whereas a pixel depicting an image that is far away is shown to be darker. Therefore, as one exemplary embodiment, the subject in FIG. 4 is shown in a brighter shade of gray, which means the subject is only a short distance away from a camera unit 110, or more specifically, to a user wearing smart glasses 100 that include a camera unit 110; whereas the subject shown in darker gray refers to the subject that is a long distance away from the user wearing smart glasses 100 that include the camera unit 110.

Then, the detection and representation unit 120 separates a hand area from a background area based on the depth map. There is no particular algorithm that the detection and representation unit 120 must use in separating the hand area from the background area, and so various image processing and recognition algorithms that have been developed or will be developed in the future, may be used. However, the detection and representation unit 120, included in the smart glasses, has certain drawbacks such as power consumption or limitations in processing capacity, so it is desirable to use an algorithm that can minimize such a problem as much as possible.

The detection and representation unit 120 may, for example, separate a hand area from a background area by using an empty space between the hand and the background. The detection and representation unit 120 may separate the hand area from the background area by defining the empty space as a boundary and setting a boundary value. In a case where the smart glasses 100 include a stereoscopic camera (i.e. a camera that houses, in a sense, a left camera and a right camera), a boundary value of the space, in which the hand and the background area are expected to be separated, is decided upon in consideration of the distance between the left and right cameras.

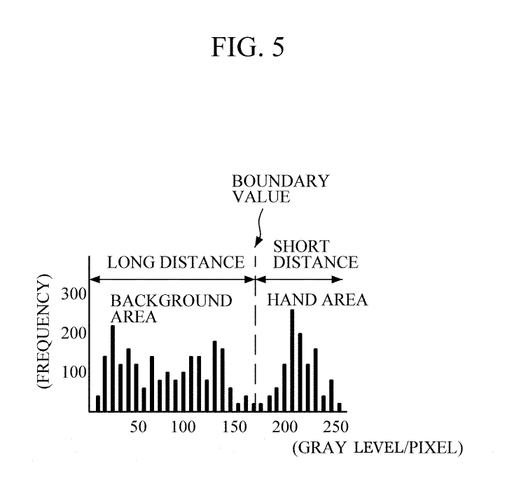

In order to use the above-mentioned characteristics in separating the hand area from the background area, the detection and representation unit 120 may generate a histogram graph of the depth map, which is then used. FIG. 5 is a graph illustrating a histogram of entire pixels forming the image of the depth map of FIG. 4. In FIG. 5, a vertical axis indicates a pixel value represented in an 8-bit gray level, and a horizontal axis indicates to a frequency of a pixel. Referring to FIG. 5, the gray level of ‘170’ is defined as a boundary value, of which a frequency is very low, but the frequencies before and after said gray level are shown relatively big in comparison to the frequency of the gray level of ‘170’, resulting in a determination that the hand and the background are separated, respectively, into the front and the back based on the space in the gray level of ‘170’. Accordingly, in this case, pixels included in a gray level greater than the boundary value (i.e., in a shorter distance than a standard) are distinguished as a hand area, whereas pixels included in a gray level smaller than the boundary value (i.e., in a longer distance than a standard) are distinguished as a background area.

As opposed to this method, the hand area and the background area may be separated by using a characteristic that a distance, where a user's hand can be away from the smart glasses 100 worn on a user, is limited. In this case, only pixels (the subject) within a predetermined range from a user are determined as the hand area, and the other pixels may be determined as the background area. For example, gray levels within a predetermined range from ‘180’ to ‘240’, i.e., only pixels within a range of a distance where a hand can be physically located, are determined as the hand area, and the other pixels may be determined as the background area.

In addition, the detection and representation unit 120 may removes noise, and if necessary, apply predetermined filtering on the resultant that is acquired in the previous operation so that the boundary between the hand and the background looks natural. To this end, the detection and representation unit 120 first extracts only pixels included in the hand area by using the resultant from the previous operation. For example, the detection and representation unit 120 may extract the hand area by allocating the values of ‘0’ and ‘1 or 255’, respectively, to the pixels determined as the hand area and the background area in the previous operation, or vice versa. Alternatively, the detection and representation unit 120 leaves the pixels, determined as the hand area in the previous operation, as they are, but to only the part determined as the background area, allocates a value of ‘0’, thereby extracting only the hand area.

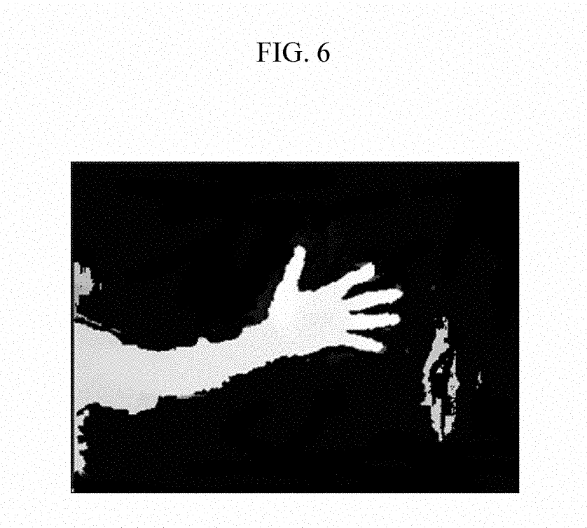

As described in the latter one above, FIG. 6 illustrates a gray-level image that is acquired by a detection and representation unit 120 that leaves pixels, determined as a hand area in the previous operation, as they are, but to only the part determined as a background area, allocates a gray-level value of ‘0’. Referring to FIG. 6, the part determined as the hand area is the same as the one illustrated in FIG. 4, but the pixels included in the rest, i.e., the background area, have been all set as ‘0’, so that it may be known that said pixels are shown in black. However, it is difficult for FIG. 5 to precisely illustrate the depth map itself. In addition, in a case of some subjects, a distance between the subject and the smart glasses 100 may be similar to a distance between the subject and the hand. Thus, it may be known that as illustrated in FIG. 6, the boundary between the hand and the background may be represented as being a little rough, or even the background includes noise that is represented as the hand area.

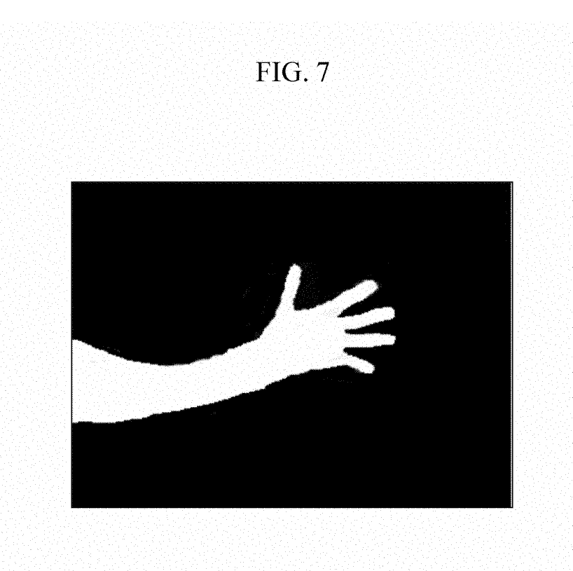

The detection and representation unit 120 softens the rough boundary and also removes the noise by applying a predetermined filtering technique. To perform this filtering, there is no specific limitation in the algorithm that the detection and representation unit 120 applies. For example, the detection and representation unit 120 may apply a filtering process, e.g., erosion and dilation being used in general image processing, thereby softening the boundary. In addition, the detection and representation unit 120 may remove the noise of a part excluding a hand area by employing a filtering technique using location information, etc., of a pixel. FIG. 7 is a diagram illustrating an example of an image that may be acquired after the above-mentioned filtering technique has been applied to the gray-level image of FIG. 6.

As opposed to what have been described above, the detection and representation unit 120 may detect a hand area by using RGB values of pixels forming an image that is acquired using a stereoscopic camera. Alternatively, the detection and representation unit 120 may use the RGB values as auxiliary data in the above-mentioned algorithm of separating a background from a hand area.

Continuously referring to FIGS. 1 to 3, the detection and representation unit 120 represents the detected hand of a user in a predetermined data format. That is, the detection and representation unit 120 represents a hand image of each frame, as illustrated in FIG. 6, as hand representation data by using a predetermined data format, i.e., metadata. Here, there is no specific limitation regarding in which manner the metadata has been systemized For example, the detection and representation unit 120 may use a data format, which has been already developed, or a new data format, which will be developed or determined, so as to represent a hand image appropriately as illustrated in FIG. 6.

In one exemplary embodiment, the detection and representation unit 120 may represent a hand image that is extracted as a format of a depth-map image (e.g., the format of JPEG or BMP).

To perform this, an original format may be applied, which is a RGB/Depth/Stereo Camera Type as specified in an MPEG-V standard. Alternatively, the detection and representation unit 120 may represent a map image more efficiently by using a format of a run-length code.

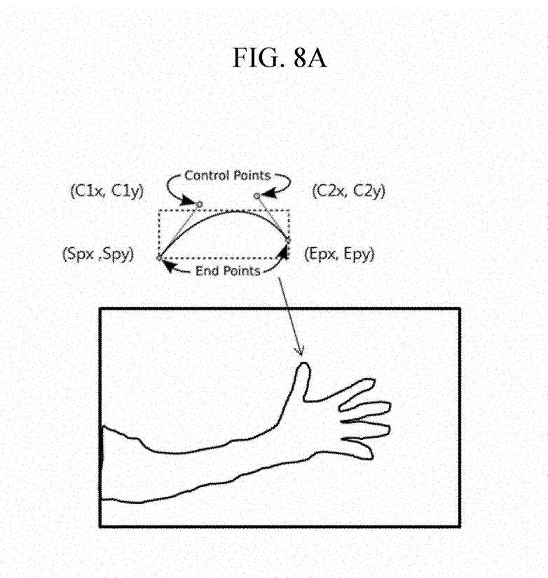

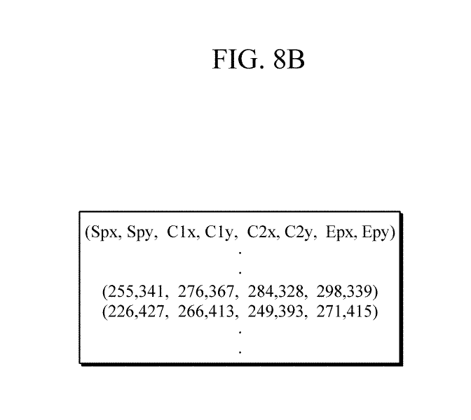

In another exemplary embodiment, the detection and representation unit 120 may represent a depth-map image in a predetermined method of representing a hand's contours with, for example, a Bézier curve. FIG. 8A is a diagram, taken from the image of FIG. 7, illustrating a part of the step in the process of showing boundary lines or contours of the hand image using a Bézier curve. FIG. 8B is a diagram illustrating a part of Bézier curve data that shows boundary lines of the hand image of FIG. 7. according to the process of FIG. 8A.

In yet another exemplary embodiment, the detection and representation unit 120 may represent a depth-map image in a format of a symbolic and geometric pattern. To perform this, the detection and representation unit 120 may apply a format of transferring an analysis result, such as an XML format compatible that is standardized in an MPEG-U standard.

Using the images acquired through the above-mentioned operation of detecting a hand image, the detection and representation unit 120 does not perform a direct recognition of a hand gesture, but represent it as hand representation data of a predetermined format of metadata, which has the following reasons and advantages.

First, in a case where the smart glasses 100 performs an operation of recognizing a hand gesture, a high-performance processor is required to be installed in the smart glasses 100, but which has limitations caused due to power consumption, electromagnetic wave generation, and heating problem. Due to these causes, a processor, installed in a wearable electronic device including the smart glasses 100, is not excellent in performance, so that it is hard to smoothly perform even operations of analyzing an image sequence and recognizing a hand gesture.

An algorithm of analyzing the image sequence and recognizing a hand gesture through such an analysis may vary, and an optimal algorithm may change depending on circumstances. However, if the smart glasses 100 entirely perform even the recognition operations of a hand gesture, the smart glasses 100 could not help but use only one predetermined algorithm, thus making it impossible to adaptively apply an optimal algorithm for recognizing a hand gesture.

In addition, the contents of a command that a specific hand gesture refers to may be different according to a cultural or social environment, etc. Therefore, if the smart glasses 100 entirely perform these recognition operations of a hand gesture, it may definitely cause a uniform process, and it is hard to process a command of a hand gesture to be suitable for various cultural or social environments.

Continuously referring to FIGS. 1 to 3, the detection and representation unit 120 transfers hand representation data, represented in a predetermined format, to a communication unit 130. Here, the ‘hand representation data’ refers to a hand image that is shown on each frame. Then, the communication unit 130 transmits the transferred hand representation data to the gesture recognition apparatus 200 by using a predetermined communication method. There is no specific limitation in a wireless communication method that is used for transmitting the hand representation data. For example, the communication unit 130 may support a short-range communications method, such as wireless local access network (WLAN), Bluetooth®, near field communication (NFC), and a mobile communications method, such as 3G or 4G LTE.

Then, the gesture recognition apparatus 200 receives the hand representation data of a plurality of frames from the smart glasses 100, and generates a gesture command by using a series of the received hand representation data in 15. The gesture recognition apparatus 200 may efficiently and quickly infer a gesture command corresponding to the specific recognized hand gesture. In addition, the gesture recognition apparatus 200 may include in advance a gesture and command comparison table in storage 230 to generate a gesture command that is adaptive to a user's environment or culture. Then, the gesture recognition apparatus 200 transmits the generated gesture command to the outside in 16. At this time, the gesture recognition apparatus 200 does not necessarily transmit the generated gesture command to the smart glasses 100, and may transmit a gesture command generated by another electronic device that is a subject controlled by a user. These operations 15 and 16 may be performed by the gesture recognition apparatus 200, which will be described hereinafter.

A communication unit 210 of the gesture recognition apparatus 200 successively receives the hand representation data from the smart glasses 100. Then, the communication unit 210 transmits, to the outside, a gesture command corresponding to the hand gesture that is recognized by a processor 220 using a series of hand representation data. Here, what is described as ‘the outside’ is not limited to the smart glasses 100, but it may be another multimedia device, such as a smartphone or a smart TV.

The processor 220 recognizes a hand gesture by processing and analyzing the hand representation data of the plurality of frames transferred from the communication unit 210. For example, based on an analysis of the plurality of the received hand images, the processor 220 determines whether the hand gesture indicates a flicking, instruction, zoom-in, zoom-out operation, or other operations. There is no specific limitation in a type of the hand gesture that is determined by the processor 220, so it could include hand gesture commands being used for a touchscreen, hand gesture commands to be used forward, or other hand gesture commands being used at another electronic device (e.g., a game console) that uses hand gestures.

The processor 220 generates a gesture command that the recognized hand gesture indicates. To this end, the storage 230 may include database (e.g., a gesture and command comparison table), which stores a correspondence relation between a plurality of hand gestures and gesture commands that correspond to each of the hand gestures. Accordingly, the processor 220 generates a gesture command corresponding to the hand gesture, which is recognized based on the gesture and command comparison table, so even the same hand gesture can lead to a different gesture command depending on the content of the gesture and command comparison table. Then, the gesture command, generated by the processor 220, is transferred to the communication unit 210 and transmitted to the outside.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. Smart glasses for a gesture recognition apparatus that recognizes a hand gesture of a user and generates a gesture command corresponding to the recognized hand gesture, the smart glasses comprising:
a camera unit configured to capture a series of images including the hand gesture of a user;
a detection and representation unit configured to represent a hand image, included in each of the series of images, as hand representation data that is represented in a predetermined format of metadata; and
a communication unit configured to transmit the hand representation data, generated by the detection and representation unit, to the gesture recognition apparatus.

2. The smart glasses of claim 1, wherein the camera unit comprises a stereoscopic camera, and the series of images are a series of left and right images that are captured by using the stereoscopic camera.

3. The smart glasses of claim 1, wherein the camera unit comprises a depth camera, and the series of images are a series of depth-map images that are captured by using the depth camera.

4. The smart glasses of claim 1, wherein the detection and representation unit is configured to distinguish between a hand area and a background area by using a depth map of each of the series of images, and represent the hand area as hand representation data.

5. The smart glasses of claim 4, wherein the hand representation data represents a boundary line of the hand area with a Bézier curve.

6. The smart glasses of claim 4, wherein the detection and representation unit is configured to determine pixels, located within a predetermined distance, as the hand area by using the depth map.

7. The smart glasses of claim 4, wherein the detection and representation unit is configured to convert the depth map of each of the series of images into a depth-map image that is represented in a predetermined bit gray level, distinguish between the hand area and the background area from the depth-map image, represent the background area all in a gray level of ‘0’, perform filtering on the hand area, and represent the hand area as the hand representation data.

8. The smart glasses of claim 7, wherein the detection and representation unit is configured to generate a histogram of a pixel frequency, and distinguish between the hand area and the background area by defining, as a boundary value, a gray level of which pixel frequency is relatively small, but the pixel frequencies before and after the gray level are bigger.

9. A system for processing a hand gesture command, the system comprising:
smart glasses configured to capture a series of images including a hand gesture of a user, and represent and transmit a hand image, included in each of the series of images, as hand representation data that is represented in a predetermined format of metadata; and
a gesture recognition apparatus configured to recognize the hand gesture of a user by using the hand representation data of the series of images received from the smart glasses, and generate and transmit a gesture command corresponding to the recognized hand gesture.

10. The system of claim 9, wherein the smart glasses are configured to distinguish between a hand area and a background area by using a depth map of each of the series of images, and represent the hand area as hand representation data.

11. The system of claim 10, wherein the hand representation data represents a boundary line of the hand area with a Bézier curve.

12. The system of claim 10, wherein the smart glasses are configured to determine pixels, located within a predetermined distance, as the hand area by using the depth map.

13. The system of claim 10, wherein the smart glasses are configured to convert the depth map of each of the series of images into a depth-map image that is represented in a predetermined bit gray level, distinguish between the hand area and the background area from the depth-map image, represent the background area all in a gray level of ‘0’, perform filtering on the hand area, and represent the hand area as the hand representation data.

14. The system of claim 13, wherein the smart glasses are configured to generate a histogram of a pixel frequency, and distinguish between the hand area and the background area by defining, as a boundary value, a gray level of which a pixel frequency is relatively small, but the pixel frequencies before and after the gray level are bigger.

15. The system of claim 9, wherein the gesture recognition apparatus is configured to store a gesture and command comparison table, which represents a correspondence relation between a plurality of hand gestures and gesture commands that correspond to each of the plurality of hand gestures, and based on the gesture and command comparison table, determine a gesture command corresponding to the recognized hand gesture.

16. The system of claim 15, wherein the gesture and command comparison table is set by the user.

17. The system of claim 9, wherein the gesture recognition apparatus is configured to transmit the generated gesture command to the smart glasses or another electronic device to be controlled by the user.

18. A method of processing a hand gesture, the method comprising:
capturing a series of images including a hand gesture of a user;
representing a hand image, included in each of the series of images, as hand representation data that is represented in a predetermined format of metadata;
transmitting the hand representation data to a gesture recognition apparatus;
recognizing, by the gesture recognition apparatus, the hand gesture of a user by using the hand representation data of the series of images received from the smart glasses, and generate and transmit a gesture command corresponding to the recognized hand gesture; and
generating and transmitting a gesture command corresponding to the recognized hand gesture.

19. The method of claim 18, wherein the representing of the hand image as the hand representation data comprises distinguishing between the hand area and the background area by using a depth map of each of the series of images, and then representing the hand area as the hand representation data.
